(19) United States
(12) Patent Application Publication
(10) Pub. No.: US 2024/0084073 A1
(43) Pub. Date: Mar. 14, 2024

(54) PEKK-BASED POWDER WITH A LOW MELTING POINT, USE IN SINTERING CONSTRUCTION PROCESSES AND CORRESPONDING OBJECTS

(71) Applicant: ARKEMA FRANCE, COLOMBES (FR)

(72) Inventors: Guillaume LE, Serquigny (FR); Benoît BRULE, Serquigny (FR); Ilias ILIPOULOS, Paris (FR)

(73) Assignee: ARKEMA FRANCE, COLOMBES (FR)

(21) Appl. No.: 18/270,141

(22) PCT Filed: Dec. 23, 2021
(86) PCT No.: PCT/FR2021/052451

§ 371 Date: Jun. 28, 2023

(30) Foreign Application Priority Data
Dec. 30, 2020 (FR) FR2014268

(51) Int. Cl. C08G 65/40; B33Y 70/00

(52) U.S. Cl. CPC C08G 65/4012; B33Y 70/00; B29K 2071/00; C08G 2650/40

(57) ABSTRACT

The invention relates to a powder based on at least one polyether ketone ketone homopolymer or copolymer essentially consisting of, or consisting of, an isophthalic repeating unit and, in the case of the copolymer, a terephthalic repeating unit (T), the isophthalic repeating unit representing at least 85% by weight relative to the total weight of said at least one polyether ketone ketone.

### TECHNICAL FIELD

The invention relates to the field of polyaryl ether ketones, also known as PAEKs, and to the field of three-dimensional construction of objects by sintering. More particularly, the invention relates to a powder based on at least one PEKK, which is suitable for use in a process for the layer-by-layer construction of objects by electromagnetic radiation-mediated sintering.

### PRIOR ART

Polyaryl ether ketones are well-known high-performance technical polymers. They may be used for applications which are restrictive in terms of temperature and/or in terms of mechanical constraints, or even chemical constraints. They may also be used for applications requiring excellent fire resistance and little emission of fumes or of toxic gases. Finally, they have good biocompatibility. These polymers are found in fields as varied as the aeronautical and aerospace sector, offshore drilling, motor vehicles, the railroad sector, the marine sector, the wind power sector, sport, construction, electronics or medical implants. In general, in conventional laser sintering processes, the PAEK powder of a layer under construction is heated in a construction environment to a temperature Tc, known as the “build temperature” or “bath temperature”, of the order of 10 to 20° C. (typically 15° C.) below its melting point. Part of the powder is then laser-sintered: it melts and then re-solidifies during cooling. For a semicrystalline PAEK powder, it is crucial for the crystallization kinetics during cooling to be suitable for avoiding, or at least minimizing, any contraction or deformation of the object under construction. In addition, a large proportion of the powder, typically about 85% to 90%, is not sintered during construction of the three-dimensional object. It therefore appears essential, for economic reasons, to be able to recycle this powder, i.e. to reuse it in subsequent build(s).

The PEEK HP3 powder, sold by the company EOS, is currently on the market of PAEK powders for laser sintering. This powder has a melting point equal to 372° C. and is used at a build temperature of about 357° C. The powder undergoes very significant thermal degradation from the first build, notably a very large increase in average molecular mass. It is thus not possible to reuse it for a second build of a three-dimensional object. Consequently, the manufacture of three-dimensional objects by sintering these powders remains far too expensive and cannot be envisaged on an industrial scale.

US 2013/0217838 proposes a solution for recycling PAEK powder with a lower melting point than PEEK HP3. In particular, it describes the possibility of fully recycling a PEKK powder at least twice, provided that the build temperature is increased and the laser beam power is increased as successive builds are performed. Said document in fact states that the PEKK powder used is not heat-stable and that its melting point increases after its first use in a sintering process. In order to be able to counter this instability of the powder, the parameters of the sintering machine are modified. A build temperature of 300° C. is used with fully recycled powder, instead of 285° C. for fresh powder. The power of the laser beam is also increased with each new build. The need to change the sintering parameters for each build slows down the industrial production and makes it more difficult. Moreover, sintering mixtures of fresh and recycled powders is particularly complex, as the build parameters vary according to the percentage of recycled powder in the mixture. Finally, the need to increase the build temperature on recycling leads to accelerated evolution of the polymer powder, to the extent that the mechanical properties and color of objects obtained from fresh or recycled powder may be quite different.

WO 2017/149233 describes a PEKK powder which can be used several times in sintering processes by virtue of an isothermal heat pretreatment at a constant temperature of between 260° C. and 290° C. for a period of between 5 minutes and 120 minutes. The isothermal heat pretreatment has the advantage of stabilizing the melting point of the powder and of enabling it to be recycled while maintaining the same build temperature for successive sintering builds.

However, this technique generally does not allow the powder to be recycled over a large number of builds, notably due to yellowing at the build temperature of 285° C. It is known from WO 2020/188202 that the addition of monosodium phosphate to PEKK powder allows this problem to be overcome, at least partly, by stabilizing the color and average molecular mass of the powder at 285° C.

Finally, a process is known from US 2018/0200959, in which the build temperature used is much lower than the build temperature of the abovementioned processes (“conventional” processes): the build temperature here is very low, being between the glass transition temperature of the constituent polymer of the powder and a temperature 30% higher than the glass transition temperature of the constituent polymer of the powder, or alternatively, between the glass transition temperature of the constituent polymer of the powder and a temperature 60° C. higher than the glass transition temperature of the constituent polymer of the powder. Relative to the conventional process, this has the advantage of slowing down the evolution of the powder's molecular mass and color, thus allowing it to be recycled more efficiently. However, this process has a number of drawbacks linked to its very low build temperature. It requires the use of a support, as the objects under construction may not be self-supported by the powder bed. Also, the energy supplied by the laser radiation must be higher than for conventional processes. This requires the use of several electromagnetic beams, which makes the process more complex to perform and/or extends the sintering time.

Thus, it appears from the abovementioned references that several approaches have already been considered at present to limit the evolution in molecular mass and color of PAEK-based powder in a process for the layer-by-layer construction of objects by electromagnetic radiation-mediated sintering: lowering the melting point of the powder, lowering the build temperature of the process, or adding stabilizer(s) to the powder composition.

There is thus a need to provide new PAEK-based powders for use in a process for the layer-by-layer construction of objects by electromagnetic radiation-mediated sintering, for which the evolution in molecular mass and color are limited and which allow the used powders to be recycled.

### AIM OF THE INVENTION

The aim of the invention is to overcome at least some of the drawbacks of the prior art.

One object of the invention is to provide a PAEK-based powder that is suitable for use in a process for the layer-by-layer construction of objects by electromagnetic radiation-mediated sintering.

An object of the invention is, at least according to certain embodiments, that objects manufactured from the powders according to the invention be able to be used under high temperature conditions.

An object of the invention is, at least according to certain embodiments, that the objects manufactured from the powders according to the invention be of good quality. In particular, the objects must have good mechanical properties.

Furthermore, the objects must comply with precise dimensioning, and notably must not show any deformation. Finally, the objects must be as smooth as possible.

Another object of the invention is, at least according to certain embodiments, that objects manufactured from the powders according to the invention have a uniform color.

Another object of the invention is, according to certain embodiments, to provide a PAEK-based powder that is suitable for recycling in successive construction processes.

Another object of the invention is, according to certain embodiments, to provide an article with satisfactory and substantially constant mechanical properties, a substantially uniform color and a sufficiently smooth appearance, irrespective of the number of times the recycled powder is recycled and irrespective of the proportion of recycled powder in the powder used.

### SUMMARY OF THE INVENTION

The invention relates to a powder based on at least one polyether ketone ketone homopolymer or copolymer essentially consisting of, or consisting of, an isophthalic repeating unit (I) having the chemical formula:

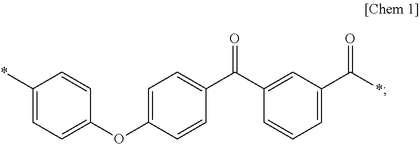

and, in the case of the copolymer, a terephthalic repeating unit (T) having the chemical formula:

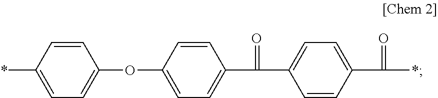

the isophthalic repeating unit representing at least 85%, or at least 90%, or at least 95%, or at least 98%, or at least 99%, or 100% by weight relative to the total weight of said at least one polyether ketone ketone.

The inventors of the present invention have thus demonstrated that the thermal characteristics of the powder according to the invention are particularly advantageous for use in a process for the layer-by-layer construction of objects by electromagnetic radiation-mediated sintering. Indeed, the crystallization kinetics of these polymers at the build temperature are sufficiently slow to allow the production of objects that are free of deformation and that have good mechanical properties in all directions.

In addition, the homopolymer or copolymers have a melting point strictly below 300° C. As a result, the powder can be sintered at a lower build temperature, at which the molecular mass changes and/or yellowing are less pronounced. These powders are consequently suitable for recycling.

According to certain embodiments, the powder may have a viscosity index of from 0.65 dl/g to 1.15 dl/g, and preferentially from 0.85 dl/g to 1.13 dl/g, as measured in solution at 25° C. in a 96% by mass aqueous sulfuric acid solution according to the standard ISO 307:2019.

According to certain embodiments, the powder may have a particle diameter distribution, measured by laser diffraction in accordance with the standard ISO 13320:2009, such that: d50<100 μm; preferentially such that: 50 μm<d50<80 μm; and extremely preferably such that: d10>15 μm, 50<d50<80 μm, and d90<240 μm.

According to certain embodiments, said at least one polyether ketone ketone may be obtained by reacting 1,3-bis(4-phenoxybenzoyl)benzene and/or 1,4-bis(4-phenoxybenzoyl)benzene with isophthaloyl chloride and/or terephthaloyl chloride.

According to certain embodiments, said powder may have undergone a heat treatment at a temperature 5° C. to 55° C. below its melting point, preferentially at a temperature 10° C. to 45° C. below its melting point, and extremely preferably at a temperature 20° C. to 42° C. below its melting point.

According to certain embodiments, said powder may have an enthalpy of fusion ΔH strictly greater than 38 J/g, preferentially greater than or equal to 41, more preferentially greater than or equal to 43 J/g and extremely preferably greater than or equal to 44 J/g, as measured according to the standard NF EN ISO 11357-3:2018, on first heating and using a temperature ramp of 20° C./min.

The invention also relates to the use of the powder in a process for the layer-by-layer construction of objects by electromagnetic radiation-mediated sintering.

The invention also relates to a process for the layer-by-layer construction of objects by electromagnetic radiation-mediated sintering of a pulverulent composition comprising a powder according to the invention, performed at a build temperature of between 205° C. and 270°, preferentially between 225° C. and 265° C., and extremely preferably between 235° C. and 255° C., limits included.

The invention also relates to a process for the layer-by-layer construction of objects by sintering, mediated by at least one electromagnetic radiation, of at least one pulverulent composition comprising at least one powder according to the invention, performed at a build temperature such that the difference between the melting point of said powder and the build temperature is greater than or equal to 25° C., notably greater than or equal to 30° C. The build temperature may notably be between 205° C. and 270° C., preferentially between 225° C. and 265° C., and extremely preferably between 235° C. and 255° C., limits included.

According to certain embodiments, the powder may be recycled with a freshness factor of less than or equal to 70%, preferentially less than or equal to 60%, and extremely preferably less than or equal to 50% by weight. The freshness factor may notably be less than or equal to 45%, or less than or equal to 40%, or less than or equal to 35%, or less than or equal to 30%, or less than or equal to 25%, or less than or equal to 20%, or even close to minimal freshness.

Finally, the invention relates to the article that may be obtained via the above process.

### LIST OF FIGURES

The invention will be understood more clearly with regard to the detailed description that follows of nonlimiting embodiments of the invention and to the following figures:

FIG. 1 schematically represents a device for performing the process for the layer-by-layer construction, at a build temperature Tc, of a three-dimensional object by sintering, in which a composition according to the invention may advantageously be used.

FIG. 2 represents the DSC thermogram, on first heating and using a temperature ramp of 20° C./min, of a powder, processed at 240° C., of PEKK homopolymer consisting solely of isophthalic repeating unit.

### DETAILED DESCRIPTION OF THE INVENTION

### Definitions

The term “powder” refers to a fractional state of matter, which is generally in the form of small pieces (particles) of very small size, generally of about a hundred micrometres or less. The term “pulverulent” refers to a composition which is as a whole in the form of a powder.

The thermograms to which reference is made in the present patent application, notably the thermogram presented in FIG. 2, may be obtained by differential scanning calorimetry (DSC) according to the standard NF EN ISO 11357-3:2018, on first heating, of about 10 mg of test powder, and using a temperature ramp of 20° C./minute. The initial temperature is about 20° C. and the final temperature is about 350° C. The thermograms may be produced, for example, using a Q2000 differential scanning calorimeter, sold by the company TA Instruments.

The term “enthalpy of fusion” denotes the heat required to make the composition melt. In the invention, it is measured on first heating using a temperature ramp of 20° C./minute.

The term “melting point” is understood to denote the temperature at which an at least partially crystalline polymer changes to the viscous liquid state. In the invention, it is measured on first heating using a temperature ramp of 20° C./minute. Unless otherwise indicated, it is more particularly the peak melting point, and, where appropriate, the temperature of the highest-temperature peak in the case where several endothermic peaks are present in the thermogram. The term “glass transition temperature”, written as Tg, is intended to denote the temperature at which an at least partially amorphous polymer passes from a rubbery state to a glassy state, or vice versa, as measured by differential scanning calorimetry (DSC) according to the standard NF ISO 11357-2: 2013, on second heating, using a heating rate of 20° C./min.

The rules for the representation of results of a particle size distribution are given by the standard ISO 9276—parts 1 to 6. The term “d₅₀” means the powder particle diameter value such that the cumulative volume-weighted particle diameter distribution function is equal to 50%. The “d₅₀” value is measured by laser diffraction according to the standard ISO 13320:2009, for example on a Malvern Mastersizer 2000® diffractometer. Similarly, “d₁₀” and “doo” are, respectively, the corresponding diameters such that the cumulative volume-weighted particle diameter function is equal to 10% and, respectively, to 90%.

The term “viscosity index” is intended to denote the viscosity as measured in solution at 25° C. in aqueous sulfuric acid solution at 96% by mass, according to the standard ISO 307:2019. The viscosity index is expressed in dl/g.

The term “mixture of polymers” is understood to denote a macroscopically homogeneous composition of polymers. The term also encompasses such compositions composed of mutually immiscible phases dispersed at the micrometric scale.

The term “homopolymer” is intended to denote a polymer comprising only one repeating unit.

The term “copolymer” is intended to denote a polymer comprising at least two different repeating units.

The term “consisting essentially of repeating unit(s)” is understood to mean that the unit(s) represent(s) a molar proportion of at least 98.5% in the polymer. In addition, the term “consisting of unit(s)” means that the unit(s) represent a molar proportion of at least 99.9%, ideally of 100%, in the polymer, not taking the chain ends into account.

The abbreviation “PEKK” stands for “polyether ketone ketone”.

The term “fresh powder” means a powder that is suitable for use for the first time in a sintering process as described below.

The term “recycled powder” means a powder of the same initial composition as the fresh powder, which has been used in at least one build according to the sintering process described below, and has not been sintered. The recycled powder may be used as is or alternatively as a mixture with other recycled powders or a fresh powder. A powder “recycled n times” for a given build n, n being an integer greater than or equal to 1, is a powder which may originate from a completed previous build (n−1). For any n greater than or equal to 2, the powder “recycled n times” in a build n may originate from the recycling of: a powder initially only recycled (n−1) times or an initial mixture of a powder recycled (n−1) times and fresh powder, used in a build (n−1). Thus, the powder recycled “n times” has undergone, at least partly, heating corresponding to the successive builds 0, . . . , (n−1). Moreover, the powder recycled “n times” has undergone, in its entirety, at least the heating of the build (n−1).

The mixture of fresh powder and recycled powder may be defined by a “freshness factor” corresponding to the mass proportion of fresh powder in the mixture of fresh powder and recycled powder.

The term “tapped density” (dimensionless) or “tapped mass per unit volume” (kg/m 3) means the density/mass per unit volume of a pulverulent material following the compacting or tapping of this material. The tapped density is measured according to the standard ISO 1068-1975 (F) in the following manner:
A volume of powder is introduced into an accurate graduated 250 ml glass measuring cylinder;
If necessary, the free surface of the powder is levelled off, without tapping it, and the volume V₀ is recorded;
The measuring cylinder with the powder is weighed on a balance with an accuracy of 0.1 g, which has been tared beforehand;
The measuring cylinder is placed on the plate of the STAV 2003 tapping machine;
It is tapped by dropping 1250 times, and the volume V1 is recorded;
It is tapped by dropping 1250 times, and the volume V2 is recorded;
The tapping operation is repeated until two equivalent volumes V1 are obtained. Vf corresponding to the identical volumes V1 is recorded.

The tapped density is the mass of powder introduced divided by Vf. The bulk density is the mass of powder introduced divided by V0. The tapped and bulk densities are both expressed in kg/m³.

The singular forms “a(n)”, or, respectively, “the” mean by default “at least one”, and, respectively, “said at least one”, unless otherwise stated.

Throughout the ranges set out in the present patent application, the limits are included, unless otherwise mentioned.

Low-Melting Polyether Ketone Ketone

The PEKK of the powder according to the invention may, according to certain embodiments, be a homopolymer essentially consisting of, or consisting of, a single isophthalic repeating unit (I), having the chemical formula:

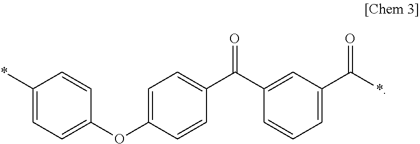

The PEKK of the powder according to the invention may, according to certain embodiments, be a copolymer essentially consisting of, or consisting of, an isophthalic repeating unit (I) and a terephthalic repeating unit (T), having the chemical formula:

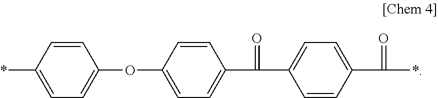

The molar proportion of T units relative to the sum of T and I units of the PEKK used in the powder according to the invention is less than or equal to 15%.

In this T/I ratio range, the PEKK has crystallization kinetics that are particularly suitable for use in powder sintering. Indeed, the crystallization kinetics at the build temperature are sufficiently slow to allow the production of objects with no deformations and having good mechanical properties in all directions.

In this T/I ratio range, the PEKK also has a melting point strictly below 300° C., as measured according to the standard NF EN ISO 11357-3:2018, on first heating and using a temperature ramp of 20° C./min. According to certain advantageous embodiments, the melting point of the PEKK is less than or equal to 290° C., or less than or equal to 280° C., or less than or equal to 275° C.

As a result, the build temperature used for sintering the powder according to the invention is lower than that used for the higher-melting PAEK powders of the prior art. This means less powder evolution and consequently easier recycling. It also allows objects to be sintered without much yellowing and with homogeneous mechanical properties.

Although having a fairly low melting point, the powder according to the invention nevertheless has a high glass transition temperature, greater than or equal to 150° C. This is particularly advantageous when envisaging the use of objects obtained by powder sintering under constrained temperature conditions.

The choice of the mass ratio of T units relative to the sum of the T and I units allows adjustments to be made, if necessary, to the melting point and crystallization rate of the powder used in powder sintering. In the abovementioned T/I ratio range, increasing the proportion of terephthalic units allows the melting point of the powder to be further reduced and the crystallization rate to be lowered.

According to the embodiments, the molar proportion of T units relative to the sum of T and I units in the PEKK may notably be equal to 15%, or less than or equal to 12.5%, or less than or equal to 10%, or less than or equal to 7.5%, or less than or equal to 5%, or less than or equal to 4%, or less than or equal to 3%, or less than or equal to 2.5%.

According to the embodiments, the molar proportion of T units relative to the sum of T and I units of the PEKK may notably be equal to 0%, or greater than or equal to 2.5%, or greater than or equal to 3%, or greater than or equal to 4%, or greater than or equal to 5%, or greater than or equal to 7.5%, or greater than or equal to 10%, or greater than or equal to 12.5%.

According to particular embodiments, the molar proportion of T units relative to the sum of the T and I units is from 0% to 1%, or from 1% to 2%, or from 2% to 3%, or from 3% to 4%, or from 4% to 5%, or from 5% to 6%, or from 6% to 7%, or from 7% to 8%, or from 8% to 9%, or from 9% to 10%, or from 10% to 11%, or from 11% to 12%, or from 12% to 13%, or from 13% to 14%, or from 14% to 15%.

The PEKK may be obtained by reacting: 1,3-bis(4-phenoxybenzoyl)benzene, 1,4-bis(4-phenoxybenzoyl)benzene, or mixtures thereof with isophthaloyl chloride, terephthaloyl chloride, or mixtures thereof, in the presence of a catalyst. This route notably allows the thermal and color stability of the PEKK to be improved.

The polymerization reaction is preferably performed in a solvent. The solvent is preferably an aprotic solvent, which may notably be chosen from the list consisting of: methylene chloride, carbon disulfide, ortho-dichlorobenzene, meta-dichlorobenzene, para-dichlorobenzene, 1,2,4-trichlorobenzene, 1,2,3-trichlorobenzene, ortho-difluorobenzene, 1,2-dichloroethane, 1,1-dichloroethane, 1,1,2,2-tetrachloroethane, tetrachloroethylene, dichloromethane, nitrobenzene, or a mixture thereof. ortho-Dichlorobenzene is particularly preferred for manufacturing the polyether ketone ketones.

The polymerization reaction is preferably performed in the presence of a Lewis acid as catalyst.

The Lewis acid may notably be chosen from the list consisting of: aluminum trichloride, aluminum tribromide, antimony pentachloride, antimony pentafluoride, indium trichloride, gallium trichloride, boron trichloride, boron trifluoride, zinc chloride, ferric chloride, stannic chloride, titanium tetrachloride and molybdenum pentachloride. Aluminum trichloride, boron trichloride, aluminum tribromide, titanium tetrachloride, antimony pentachloride, ferric chloride, gallium trichloride and molybdenum pentachloride are preferred. Aluminum trichloride is particularly preferred for manufacturing polyether ketone ketones.

According to certain embodiments, a Lewis base may also be added to the reaction medium, as described in U.S. Pat. No. 4,912,181. This may make it possible to delay the appearance of a massive gel, which generally complicates the implementation of certain steps of the manufacturing process.

According to certain embodiments, a dispersant may also be added to the reaction medium, as described in WO 2011/004164 A2. This may allow the polymer to be obtained in the form of dispersed particles that are easier to handle.

The polymerization may be performed at a temperature ranging, for example, from 20 to 120° C.

The process for manufacturing PEKK advantageously comprises one or more steps of purifying the polymer, such as the steps of:
mixing the PEKK-containing polymerization reaction products with a protic solvent so as to provide a PEKK suspension;
separating the PEKK polymer from the suspension, preferably by filtration and washing.

The protic solvent used for the PEKK suspension may be, for example, an aqueous solution, methanol, or a mixture of an aqueous solution and methanol.

The PEKK polymer may then be recovered from the suspension by filtration. If necessary, the polymer may be washed, preferably with a protic solvent such as methanol, and filtered again, one or more times. The washing may be performed, for example, by resuspending the polymer in the solvent.

Powder

The powder based on at least one polyether ketone ketone according to the invention generally comprises at least 50% by weight of a PEKK or of a mixture of PEKKs, relative to the total weight of powder.

In certain embodiments, the powder comprises at least 75%, or at least 80%, or at least 85%, or at least 90%, or at least 92.5%, or at least 95%, or at least 97.5%, or at least 98%, or at least 98.5%, or at least 99%, or at least 99.5%, or 100% by weight of PEKK(s) relative to the total weight of powder.

In certain embodiments, the PEKK-based powder may comprise only one PEKK with a given chemical composition, for example homopolymer only.

Alternatively, the PEKK-based powder may comprise at least two different types of PEKK with different chemical compositions. In other words, the PEKK powder may comprise two PEKKs with different T/I ratios. For example, the PEKK-based powder may comprise isophthalic homopolymer and a copolymer with a T/I mole ratio strictly greater than 0% and less than or equal to 15%.

The powder may comprise one or more other polymers, notably thermoplastics, not being the PEKK used in the powder according to the invention. This other polymer may be another PAEK with a melting point less than or equal to 300° C., preferentially a melting point less than or equal to that of the PEKK in the powder. This other polymer may also be a polymer not belonging to the PAEK family, for instance a polyetherimide (PEI).

According to certain embodiments, the powder has a viscosity index, measured as a solution at 25° C. in aqueous sulfuric acid solution at 96% by mass according to the standard ISO 307:2019, of from 0.65 dl/g to 1.15 dl/g, preferentially from 0.85 dl/g to 1.13 dl/g.

These viscosity indices are particularly advantageous and make it possible to obtain a good compromise to have both good coalescence properties during sintering (sufficiently low viscosity) and good mechanical properties of the sintered object (sufficiently high viscosity).

According to certain embodiments, the viscosity index, measured as a solution at 25° C. in aqueous sulfuric acid solution at 96% by mass according to the standard ISO 307:201, may notably be strictly greater than 0.9 dl/g or strictly greater than 1 dl/g. The viscosity index may be, for example, from 1.05 dl/g to 1.15 dl/g.

The powder may have a tapped density of from 200 to 550 kg/m 3, preferentially from 250 to 510 kg/m 3, and extremely preferably from 300 to 480 kg/m 3. Powder densification may be achieved by means of a thermo-mechanical treatment in a manner known per se, for example set out in US 2017/312938. A high-speed mixer may notably be used, with a stirring rotor having at least one blade whose tip speed may be between 30 and 70 m/s. The duration of the thermo-mechanical treatment may notably be from 30 to 120 minutes. Mixing may be performed with or without temperature control, the temperature generally not exceeding 100° C. in any case during this step.

The powder may also comprise one or more additives. The additives generally represent less than 5% by weight relative to the total weight of the composition. Preferably, the additives represent less than 1% by weight relative to the total weight of the powder. Among the additives, mention may be made of flow agents, stabilizers (light, in particular UV, and heat stabilizers), nucleating agents (polymeric or inorganic), optical brighteners, dyes, pigments and energy-absorbing additives (including UV absorbers).

According to certain embodiments, the powder comprises a phosphate. The phosphate may notably be a phosphate salt, for instance a salt of H₂PO₄⁻, HPO₄²⁻, PO₄³⁻, or a mixture thereof, preferentially having a sodium ion, a potassium ion or a calcium ion as counterion. The phosphate may be incorporated into the composition in a proportion greater than or equal to ppm, or greater than or equal to 50 ppm, or greater than or equal to 100 ppm.

Advantageously, the phosphate is incorporated into the composition in a proportion of greater than or equal to 500 ppm, or greater than or equal to 750 ppm, or greater than or equal to 1000 ppm, or greater than or equal to 1500 ppm, or greater than or equal to 2000 ppm, or greater than or equal to 2500 ppm.

According to other embodiments, the powder does not comprise any phosphate.

According to certain embodiments, the powder may comprise a flow agent, for example a hydrophilic or hydrophobic silica. Advantageously, the flow agent represents from 0.01% to 0.4% by weight relative to the total weight of the powder.

According to other embodiments, the powder does not comprise any flow agent. The powder may also comprise one or more fillers. The fillers represent less than 50% by weight and preferably less than 40% by weight relative to the total weight of the composition. Among the fillers, mention is made of reinforcing fillers, notably mineral fillers such as carbon black, talc, carbon or non-carbon nanotubes, fibers (glass, carbon, etc.), which may or may not be milled.

Certain polymers other than PEKK(s), and certain additives and/or certain reinforcing fillers may be incorporated into the PEKK(s), for example by melt extrusion by compounding and then milling granules, in order to form a PEKK-based powder incorporating these other constituents.

Certain polymers other than PEKK(s), and/or certain additives and/or certain reinforcing fillers may be dry-blended with the PAEK-based powder.

According to certain embodiments, the powder may be a dry blend of a PEKK powder incorporating a reinforcing filler and a PEKK powder not comprising any reinforcing filler. The powder may notably be a dry blend of a PEKK powder incorporating a reinforcing filler by compounding and of a PEKK powder not comprising any reinforcing filler.

The powder may be obtained by milling according to techniques known to those skilled in the art.

The milling of polymer flakes or of extruded granules may be performed at a temperature below −20° C., preferentially at a temperature below −40° C., by cooling with liquid nitrogen, or liquid carbon dioxide, or cardice, or liquid helium. In other embodiments, notably in the case of polymer flakes, the milling may be performed at room temperature, i.e. at a temperature that may notably be from 15° C. to 35° C., for example 25° C.

The powder may have a particle size distribution having a median diameter d₅₀ of the distribution such that: d₅₀<100 μm. Preferentially, the d₅₀ is such that: 40<d₅₀<80. In more preferred embodiments, the particle size distribution is such that d₁₀>15 μm, 40<d₅₀<80 μm, and d₅₀<240 μm. In certain embodiments, d₅₀<220 μm or d₅₀<200 μm. These particle size distributions are particularly advantageous for powders intended to be used in a sintering process.

The powder according to the invention may have undergone at least one heat treatment at a temperature of from 205° C. to 270° C. during its manufacturing process. The heat treatment allows the production of a powder with a stable crystalline morphology, i.e. a powder which essentially does not undergo melting up to the build temperature. The powder may notably have been heated to a temperature 5° C. to 55° C. below its melting point, preferentially to a temperature 10° C. to 45° C. below its melting point, and extremely preferably to a temperature 20° C. to 42° C. below its melting point.

In the case of PEKK homopolymer, the powder may notably have been heat-treated at a temperature of from 220° C. to 270° C., preferentially at a temperature of from 230° C. to 265° C., and extremely preferably at a temperature of from 240° C. to 260° C.

The duration of such a heat treatment may be longer or shorter depending on the embodiment. It is generally less than or equal to 6 hours and preferentially less than or equal to 4 hours. It is generally greater than or equal to 10 minutes, and usually greater than or equal to 30 minutes.

According to certain embodiments, the powder according to the invention has an enthalpy of fusion ΔH strictly greater than 38 J/g, preferentially greater than or equal to 41, more preferentially greater than or equal to 43 J/g and extremely preferably greater than or equal to 44 J/g, as measured according to the standard NF EN ISO 11357-3:2018, on first heating and using a temperature ramp of 20° C./min. High enthalpies of fusion notably allow a reduction in unsintered powder agglomerates within the powder bath and/or an improvement in the smooth surface appearance of the sintered objects.

Sintering Process

The powder according to the invention, or more generally a pulverulent composition derived therefrom, is suitable for use in a process for the layer-by-layer construction of three-dimensional objects by electromagnetic radiation-mediated sintering.

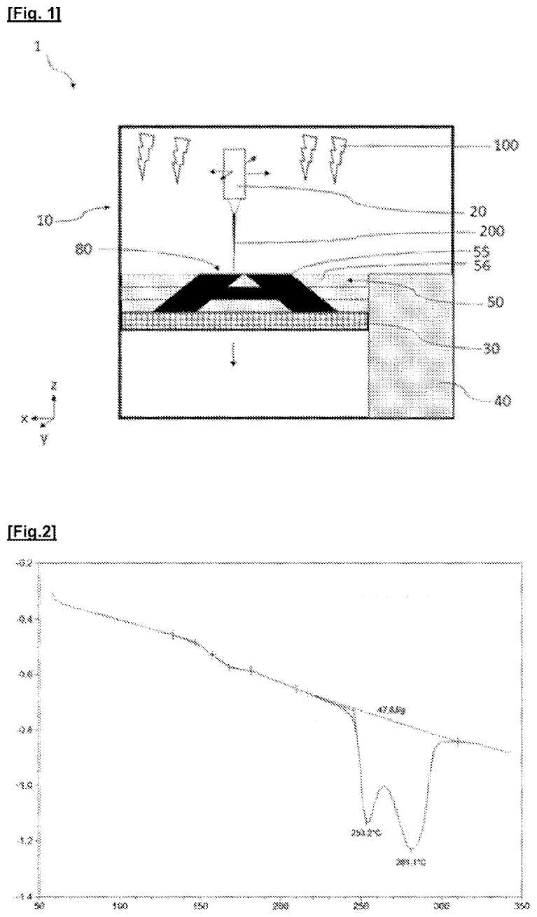

An implementation device 1 for obtaining a three-dimensional object 80 is shown schematically in FIG. 1.

The electromagnetic radiation may be, for example, infrared radiation, ultraviolet radiation or, preferably, laser radiation. In particular, in a device 1 such as the one shown diagrammatically in FIG. 1, the electromagnetic radiation may comprise a combination of infrared radiation 100 and laser radiation 200.

The device 1 comprises a sintering chamber 10 in which are placed a feed tank containing the PEKK-based powder and a movable horizontal plate 30. The horizontal plate 30 may also act as a support for the three-dimensional object 80 under construction. Nevertheless, the objects manufactured from the powder according to the invention generally do not require any additional support and can generally be self-supported by the unsintered powder of preceding layers. According to the process, powder is taken from the feed tank 40 and deposited on the horizontal plate 30, forming a thin layer 50 of powder constituting the three-dimensional object 80 under construction. The layer 50 of powder is heated by means of an infrared radiation 100 to reach a substantially uniform temperature equal to the predetermined minimum build temperature Tc. Means for determining Tc are known per se and may require the creation of a DSC thermogram such as that shown in FIG. 2.

The build temperature may be from 205° C. to 270° C., i.e. lower than that of the PAEK powders according to the prior art. The build temperature may preferentially be from 225° C. to 265° C. Such a low build temperature is made possible due to the fact that the powder according to the invention comprises a low-melting PEKK.

According to certain advantageous embodiments, and surprisingly, the difference between the melting point and the build temperature may be strictly greater than 25° C., even when using a “conventional” construction process.

According to certain embodiments, this difference may notably be greater than or equal to 30° C.

The build temperature may notably be from 225° C. to 230° C., or from 230° C. to 235° C., or from 235° C. to 240° C., or from 240° C. to 245° C., or from 245° C. to 250° C., or from 250° C. to 255° C., or from 255° C. to 260° C., or from 260° C. to 265° C.

The energy required to sinter the powder particles at various points in the powder layer 50 is then provided by laser radiation 200 from the laser 20 that is movable in the plane (xy), in a geometry corresponding to that of the object. The molten particles resolidify forming a sintered part 55, whereas the rest of the layer 50 remains in the form of unsintered powder 56. A single pass of a single laser radiation 200 is generally sufficient to ensure the sintering of the powder.

Nevertheless, in certain embodiments, several passes at the same place and/or several electromagnetic radiations reaching the same place may also be envisaged to ensure the sintering of the powder.

Next, the horizontal plate 30 is lowered along the axis (z) by a distance corresponding to the thickness of one layer of powder, and a new layer is deposited. The laser 20 supplies the energy required to sinter the powder particles in a geometry corresponding to this new slice of the object, and so on. The procedure is repeated until the entire object 80 has been manufactured. The temperature in the sintering chamber 10 of the layers under the layer undergoing construction may be below the construction temperature. However, this temperature generally remains above, or even well above, the glass transition temperature of the powder. It is notably advantageous for the temperature of the bottom of the chamber to be maintained at a temperature Tb, known as the “tank bottom temperature”, such that Tb is less than Tc by less than 40° C., preferably by less than 25° C. and more preferably by less than 10° C.

Once the object 80 has been completed, it is removed from the horizontal plate and the unsintered powder 56 can be screened before being returned, at least partly, into the feed tank 40 to serve as recycled powder.

The build temperature used for the sintering process using a powder comprising recycled powder is advantageously the same as that for the process using only fresh powder.

The recycled powder may be used as such or alternatively as a mixture with fresh powder.

According to certain embodiments, the unsintered powder is entirely recycled, which means that the powder has a freshness factor of only 10% to 15%, given that only 10% to 15% by weight of powder is usually sintered to obtain an object.

According to certain embodiments, the powder may have a freshness factor of less than or equal to 70%, preferentially less than or equal to 60%, and even more preferentially less than or equal to 50%. The powder may notably have, advantageously, a freshness factor less than or equal to 45%, or less than or equal to 40%, or less than or equal to 35%, or less than or equal to 30%, or less than or equal to 25%, or less than or equal to 20%, or even close to minimal freshness.

According to certain embodiments, the mixture of recycled powder and fresh powder may comprise at least 30%, preferentially at least 40%, and very preferentially at least 50% recycled powder relative to the total weight of the mixture. The mixture may notably comprise, advantageously, at least 55%, or at least 60%, or at least 65%, or at least 70%, or at least 75%, or at least 80% by weight of recycled powder, or even tend towards a powder comprising as little fresh powder as possible.

Object which May be Obtained or which is Directly Obtained Via the Sintering Process

The objects obtained via the sintering process have good mechanical properties, notably a high elastic modulus in at least one direction. The mechanical properties are advantageously homogeneous in all directions.

The objects obtained show no apparent deformations and have a smooth surface appearance. Their color is globally homogeneous.

### Examples

### Example 1: PEKK Isophthalic Homopolymer Powder

A PEKK homopolymer consisting of the isophthalic repeating unit was manufactured as follows:

ortho-Dichlorobenzene and 1,3-bis(4-phenoxybenzoyl)benzene were placed in a 2 L reactor with stirring and under a stream of nitrogen. A mixture of isophthaloyl chloride and benzoyl chloride was then added to the reactor. The reactor was cooled to −5° C. Aluminum trichloride AlCl₃ was added while keeping the temperature in the reactor below 5° C. After a homogenization period of about 10 minutes, the reactor temperature was increased by 5° C. per minute up to a temperature of 90° C. (it is considered that the polymerization commences during the temperature increase). The reactor was maintained at 90° C. for 30 minutes and then cooled to 30° C. Concentrated hydrochloric acid solution (3.3% by weight of HCl) was then added slowly so that the temperature in the reactor did not exceed 90° C. The reactor was stirred for 2 hours and then cooled to 30° C. The PEKK thus formed was separated from the liquid effluents and then washed in the presence or absence of acid according to the usual separation/washing techniques that are well known to those skilled in the art, so as to obtain a “purified wet PEKK”. The purified wet PEKK was dried at 190° C. under vacuum (30 mbar) for 48 hours. Polymer flakes were obtained. A viscosity index of 0.87 dl/g was measured as a solution at 25° C. in aqueous sulfuric acid solution at 96% by mass according to the standard ISO 307:2019.

The polymer flakes obtained were micronized in an Alpine Hosokawa AFG 200 air jet mill at a temperature of 23° C. in order to obtain a powder having as particle size distribution, d10=22 microns, d50=52 microns and d90=101 microns, in a yield of 98%.

The powder obtained was then subjected to a heat treatment of 240° C. for 4 hours in order to obtain a heat-treated powder.

A thermogram of the powder was produced, on first heating and with a temperature ramp of 20° C./min, and is shown in FIG. 2. It enabled determination of the minimum build temperature at 250° C. for a melting point equal to 281.1° C. The total enthalpy of the powder was measured at 47.8 J/g.

Type 1 BA specimens, in accordance with the standard ISO 527-2:2012, are manufactured by laser sintering with the (fresh) powder from the example in an EOS P810® printer. The specimens are built along the X, Y and Z axes, at a build temperature of 250° C., and with a laser energy for sintering of 30 mJ/mm². All the specimens are warp-free, homogeneously colored and have a good surface appearance.

The unsintered powder recovered on conclusion of the process was at a temperature of 250° C. or less throughout the specimen construction period. As this temperature is relatively low compared with that used in conventional sintering processes in the prior art, the molar mass and color of the powder change relatively little during sintering construction. This has several advantages: i) the sintered objects have homogeneous mechanical and color properties; ii) objects sintered from at least partially recycled powder are of similar quality to those obtained from totally fresh powder and iii) the powder may be recycled a greater number of times without this having any significant impact on the mechanical and color properties of the sintered object.

### Comparative Example: PEKK Powder with a T/I Mole Ratio Equal to 60/40

A PEKK powder was manufactured under conditions analogous to those of Example 1, except that 1,4-bis(4-phenoxybenzoyl)benzene instead of 1,3-bis(4-phenoxybenzoyl)benzene and a mixture of isophthaloyl chloride and terephthaloyl chloride instead of isophthaloyl chloride were used.

A powder having the following particle size distributions: d10=21 microns, d50=50 microns and d90=98 microns, was obtained.

The pre-densified powder was subjected to heat treatment at 285° C. for 4 hours, so as to obtain a heat-treated powder.

A thermogram of the powder was produced, on first heating and with a temperature ramp of 20° C./min. It enabled determination of the minimum build temperature at 279° C. for a melting point equal to 301° C. The total enthalpy of the powder was measured at 33.2 J/g.

The isophthalic PEKK homopolymer of Example 1 thus has a lower melting point and a higher total enthalpy than the PEKK with a T/I ratio of 60/40 of the comparative example.

In addition, the difference between its build temperature and melting point is greater than that of PEKK with a T/I ratio of 60/40. This thus makes it possible to envisage performing processes for the layer-by-layer construction of objects by sintering mediated by at least one electromagnetic radiation, at build temperatures lower than those which would normally have been expected according to conventional construction processes.

1. A powder based on at least one polyether ketone ketone homopolymer or copolymer essentially consisting of an isophthalic repeating unit (I) having the chemical formula: 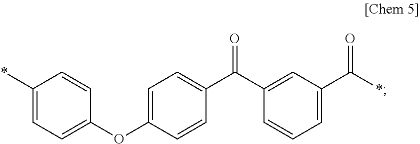
and, in the case of the copolymer, a terephthalic repeating unit (T) having the chemical formula: 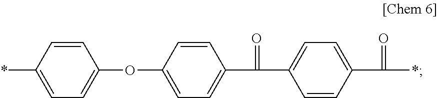
the isophthalic repeating unit representing at least 85% by weight relative to the total weight of said at least one polyether ketone;
said powder being characterized by an enthalpy of fusion ΔH strictly greater than 38 J/g as measured according to the standard NF EN ISO 11357-3:2018, on first heating, using a temperature ramp of 20° C./minute.

2. The powder as claimed in claim 1, having a viscosity index of from 0.65 dl/g to 1.15 dl/g, as measured in solution at 25° C. in a 96% by mass aqueous sulfuric acid solution according to the standard ISO 307:2019.

3. The powder as claimed in claim 1, having a particle diameter distribution, measured by laser diffraction in accordance with the standard ISO 13320:2009, such that: d50<100 μm.

4. The powder as claimed in claim 1, in which said at least one polyether ketone may be obtained by reacting 1,3-bis(4-phenoxybenzoyl)benzene and/or 1,4-bis(4-phenoxybenzoyl)benzene with isophthaloyl chloride and/or terephthaloyl chloride.

5. The powder as claimed in claim 1, which has undergone a heat treatment at a temperature 5° C. to 55° C. below its melting point.

6. The powder as claimed in claim 1, which is characterized by an enthalpy of fusion ΔH greater than or equal to 41 J/g, as measured according to the standard NF EN ISO 11357-3:2018, on first heating and using a temperature ramp of 20° C./min.

7. A method using the powder as claimed in claim 1, in at least one process for the layer-by-layer construction of objects by sintering mediated by at least one electromagnetic radiation.

8. A process for the layer-by-layer construction of objects by sintering, mediated by at least one electromagnetic radiation, of at least one pulverulent composition comprising at least one powder as claimed in claim 1, performed at a build temperature such that the difference between the melting point of said powder and the build temperature is greater than or equal to 25° C.

9. The process as claimed in claim 8, performed at a build temperature of between 205° C. and 270° C. limits included.

10. The process as claimed in claim 8, in which said at least one powder may be recycled with a freshness factor of less than or equal to 70%.

11. An article which may be obtained via a process as claimed in claim 8.
